(19) United States
(12) Patent Application Publication
(10) Pub. No.: US 2006/0061412 A1
(43) Pub. Date: Mar. 23, 2006

(54) High precision, curvature compensated bandgap reference circuit with programmable gain

(75) Inventors: Johnnie Molina, Tucson, AZ (US); Hugo Cheung, Tucson, AZ (US); Ramesh Saripalli, Tucson, AZ (US); Ritu Ghosh, Tucson, AZ (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/945,750

(22) Filed: Sep. 20, 2004

(51) Int. Cl. G05F 1/10

(52) U.S. Cl. 327/539

(57) ABSTRACT

A high precision, curvature compensated bandgap reference circuit with programmable gain is provided. An exemplary bangap reference circuit comprises a curvature compensation circuit configured for compensation of the temperature coefficient characteristic of the bandgap reference circuit, and a programmable gain circuit configured for adjusting the gain the output of the curvature compensation circuit to provide a high precision reference voltage. To facilitate high precision and accuracy, each of the curvature compensation circuit and the programmable gain circuit are configured for trimming during operation/after manufacture. Trimming of the temperature compensation circuit is facilitated by a first digital-to-analog (DAC) device. The programmable gain circuit comprises a gain trimming circuit comprising a second DAC. The first DAC and second DAC can be suitably controlled in various manners, including use of microcontroller circuit having flash memory configured for storing and loading trim values into the first DAC and second DAC.

### FIELD OF INVENTION

The present invention relates to a bandgap reference for use in integrated circuits. More particularly, the present invention relates to a high precision, curvature compensated bandgap reference circuit with programmable gain.

### BACKGROUND OF THE INVENTION

The demand for less expensive, and yet more reliable integrated circuit components for use in mobile communication, imaging and high-quality video applications continues to increase rapidly. As a result, integrated circuit manufacturers are requiring greater accuracy in voltage references for such components and devices to meet the design requirements of such a myriad of emerging applications.

Voltage references are generally required to provide a substantially constant output voltage despite gradual or momentary changes in supply voltage, output current or temperature. In particular, many designers have utilized bandgap reference circuits due to their ability to provide a stable voltage supply that is insensitive to temperature variations over a wide temperature range. These bandgap references rely on certain temperature-dependent characteristics of the base-emitter voltage, V_{BE}, of a transistor. Typically, these bandgap reference circuits operate on the principle of compensating the negative temperature coefficient of a base-emitter voltage, V_{BE} of a bipolar transistor with the positive temperature coefficient of the proportional-to-absolute-temperature (PTAT) voltage V_{PTAT}. In general, V_{PTAT}=k*T/q*k2, where k is Boltzmann's constant, T is the absolute temperature in degrees Kelvin, q is the electronic charge, and k2 is a constant representative of the term ln(k3), wherein k3 is defined by the ratio of the area and current through two bipolar devices whose difference in base-emitter voltage V_{BE} generates the V_{PTAT}=k*T/q*ln(k3) term. In general, the negative temperature coefficient of the base-emitter voltage V_{BE} is summed with the positive temperature coefficient of the proportional-to-absolute-temperature (PTAT) voltage V_{PTAT}, which is appropriately scaled such that the resultant summation provides a zero temperature coefficient.

Conventional bandgap technologies generally comprise circuits designed to generate a positive temperature coefficient through a proportional-to-absolute-current I_{PTAT} flowing through a resistor. For example, with reference to FIG. 1, a voltage circuit 100 configured to provide a bandgap voltage V_{BG} comprises a positive temperature coefficient generated by a proportional-to-absolute-temperature current I_{PTAT} flowing through a resistor R, and a negative temperature coefficient of the base-emitter voltage V_{BE} generated from proportional-to-absolute-current I_{PTAT} flowing through a bipolar transistor D₁. For trimming of voltage reference circuit 100 for curvature compensation, laser trimmed or fusible links R_{TRIM}, or electrically erasable programmable read-only memory (EEPROM), can be suitably utilized to trim out resistance. However, the trimming process occurs only during manufacturing such that the user cannot further change reference circuit 100, thus limiting the ability for temperature drift correction after manufacturing. As a result, such reference circuits are not ideal for applications in which high precision and accuracy are desired.

### SUMMARY OF THE INVENTION

In accordance with various aspects of the present invention, a high precision, curvature compensated bandgap reference circuit with programmable gain is provided. In accordance with an exemplary embodiment of the present invention, an exemplary bangap reference circuit comprises a temperature curvature compensation circuit and a programmable gain circuit. The curvature compensation circuit is configured for compensation of the temperature coefficient characteristic of the bandgap reference circuit, while the programmable gain circuit is configured for adjusting the gain the output of the curvature compensation circuit to provide a high precision reference voltage. To facilitate high precision and accuracy, each of the curvature compensation circuit and the programmable gain circuit are configured for trimming during operation or otherwise after manufacture.

In accordance with an exemplary embodiment, the temperature compensation circuit comprises a negative temperature coefficient generating circuit and a positive temperature coefficient generating circuit. Trimming of the positive temperature coefficient is facilitated by a first digital-to-analog (DAC) device. The programmable gain circuit comprises a curvature compensation component and a gain trimming circuit comprising a second DAC. The first DAC and second DAC can be suitably controlled in various manners, including use of microcontroller circuit having flash memory configured for storing trim values and loading those values into the first DAC and second DAC during reset and/or power-on phases of the microcontroller circuit.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates a schematic diagram of a prior art bandgap reference circuit;

FIG. 2 illustrates an exemplary bandgap reference circuit in accordance with an exemplary embodiment of the present invention;

FIG. 3 illustrates a schematic diagram of an exemplary temperature curvature compensation circuit in accordance with an exemplary embodiment of the present invention;

FIG. 4 illustrates a schematic diagram of an exemplary programmable gain circuit in accordance with an exemplary embodiment of the present invention; and

FIG. 5 illustrates a block diagram of an exemplary microcontroller circuit in accordance with an exemplary embodiment of the present invention.

### DETAILED DESCRIPTION

The present invention may be described herein in terms of various functional components and various processing steps. It should be appreciated that such functional components may be realized by any number of hardware or structural components configured to perform the specified functions. For example, the present invention may employ various integrated components, e.g., buffers, supply rail references, current mirrors, and the like, comprised of various electrical devices, e.g., resistors, transistors, capacitors, diodes and the like whose values may be suitably configured for various intended purposes. In addition, the present invention may be practiced in any integrated circuit application where high precision reference voltages are desired. Further, it should be noted that while various components may be suitably coupled or connected to other components within exemplary circuits, such connections and couplings can be realized by direct connection between components, or by connection through other components and devices located thereinbetween.

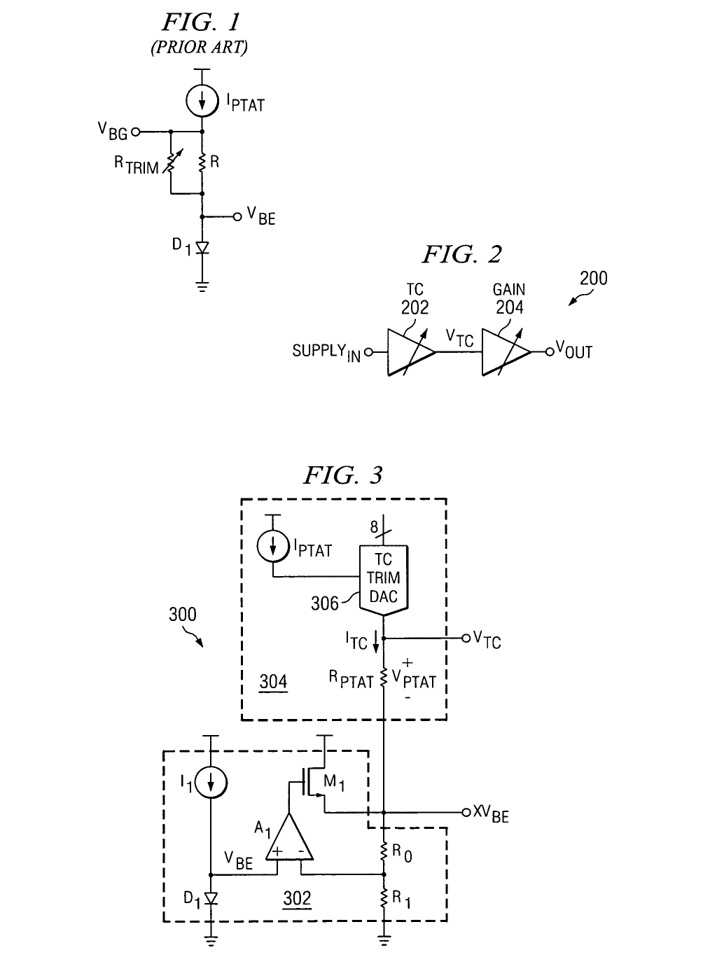

In accordance with various aspects of the present invention, a high precision, curvature compensated bandgap reference circuit with programmable gain is provided. In accordance with an exemplary embodiment of the present invention, with reference to FIG. 2, an exemplary bangap reference circuit 200 comprises a temperature curvature compensation circuit 202 and a programmable gain circuit 204. Curvature compensation circuit 202 is configured for receiving a supply signal SUPPLY_{IN} and for providing compensation of the temperature coefficient characteristic of bandgap reference circuit 200 to provide a temperature compensated voltage V_{TC}, i.e., for providing a linear response curve for changes in voltage over changes in temperature for bandgap reference circuit 200. Curvature compensation circuit 202 can comprise various circuit configurations for providing temperature curvature correction. Programmable gain circuit 204 is configured for adjusting the gain of the output signal of the curvature compensation circuit, i.e., gain of temperature compensated voltage V_{TC}, to provide a high precision reference voltage V_{OUT}. To facilitate high precision and accuracy, each of curvature compensation circuit 202 and programmable gain circuit 204 are configured for trimming during operation or otherwise after manufacture.

In accordance with an exemplary embodiment, a temperature compensation circuit comprises a negative temperature coefficient generating circuit and a positive temperature coefficient generating circuit. For example, with reference to FIG. 3, in accordance with an exemplary embodiment, a temperature compensation circuit 300 comprises a negative temperature coefficient generating circuit 302 and a positive temperature coefficient generating circuit 304. Negative temperature coefficient generating circuit 302 is configured for generating a negative temperature coefficient characteristic, i.e., a negative temperature drift, with a base-emitter voltage V_{BE1} generated from a current I₁ flowing through a bipolar transistor, represented by a diode D₁. In accordance with this exemplary embodiment, negative temperature coefficient generating circuit 302 is configured to multiply base-emitter voltage V_{BE1} through an amplifier circuit comprising a servo amplifier A₁, an output transistor M₁ and a multiplier network comprising resistors R₀ and R₁, with base-emitter voltage V_{BE1} being multiplied X times by the ratio of resistors R₀/R₁. In other words, (R₀/R₁)*V_{BE1}=X V_{BE}, for example, (R₀/R₁)*V_{BE}=1.4 V_{BE1} or some other suitable ratio X. Servo amplifier A₁ can comprise any configuration for amplification of signals.

Positive temperature coefficient generating circuit 304 is configured to generate a positive temperature coefficient voltage V_{PTAT} through a trimmed, proportional-to-absolute-temperature current I_{PTAT} eventually flowing through a resistor R_{PTAT}. For example, a first digital-to-analog (DAC) device 306 is configured for trimming of the positive temperature coefficient of proportional-to-absolute-current I_{PTAT} to provide a trimmed current I_{TC}, resulting in positive temperature coefficient voltage V_{PTAT}. As a result, a digitally trimmed, temperature compensated voltage V_{TC} can be provided from temperature compensation circuit 300, with temperature compensated voltage V_{TC}=(I_{TC}×R_{PTAT})+X V_{BE}.

DAC device 306 can comprise various configurations for facilitating trimming of temperature compensated voltage V_{TC}. For example, DAC device 306 can suitably comprise any conventional current output DAC device configured for receiving a current reference, e.g., proportional-to-absolute-current I_{PTAT}, and for providing an output current, e.g., trimmed current I_{TC}, that is a binary weighted representation of the current reference. DAC device 306 can also comprise an internal DAC device used for manufacturing trim of a bandgap reference circuit, or a separate DAC device. Thus, for example, with momentary reference to FIG. 5, an exemplary DAC device 306 for trimming of temperature compensated voltage V_{TC} may be configured within a bandgap reference circuit 506 of a microcontroller device 500, and can be suitably controlled by a central processing unit (CPU) 504, such as through a special function register (SFR). However, DAC device 306 can also be suitably controlled through various other techniques, such as with an external controller and/or memory. In addition, DAC device 306 can comprise various sizes and resolution, for example an 8-bit DAC device, a 16-bit device, or any other desired configuration.

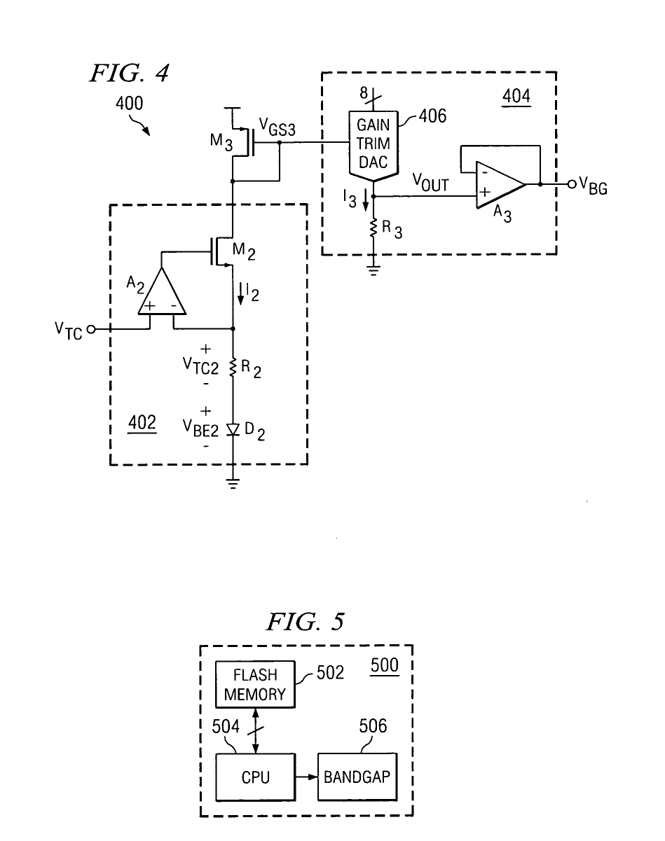

An exemplary programmable gain circuit can comprise various configurations for adjusting the gain of the output signal of temperature curvature compensation circuit to provide a high precision reference voltage V_{OUT}. For example, with reference to FIG. 4, a programmable gain circuit 400 can comprise an additional curvature compensation component 402 and a gain trimming circuit 404 comprising a second DAC device 406. Curvature compensation component 402 can comprise an additional circuit configured with temperature compensation circuit 300 to provide another V_{BE} component for facilitating generation of a voltage reference V_{TC2} for gain trimming circuit 404. In accordance with an exemplary embodiment, curvature compensation component 402 can comprise an amplifier A₂ having a positive terminal configured for receiving temperature compensated voltage V_{TC} and a negative terminal configured in a feedback arrangement with output transistor M₂ and a base-emitter voltage V_{BE2} (generated from a PNP-based bipolar transistor as represented by a diode D₂), to provide a difference voltage V_{TC2}. In turn, difference voltage V_{TC2} is suitably divided by a resistor R₂ to generate a current I₂. In other words: V_{TC2}/R₂=(V_{TC}−V_{BE2})/R₂=I₂.

Gain trimming circuit 404 comprises a gain trim DAC device 406 configured for receiving temperature compensated reference signal I₂=V_{TC2}/R₂ and for generating a trimmed output reference V_{OUT}. For example, in accordance with an exemplary embodiment, a digitally trimmed current I₃ equal to a constant K times current I₂, i.e., I₃=K*I₂, can be provided to flow through a resistor R₃ to generate an output reference V_{OUT}. In accordance with an exemplary embodiment, for generating a voltage reference for gain trimming circuit 404, programmable gain circuit 400 can also comprise a transistor M₃ configured to generate a gate-source voltage V_{GS3}, as driven by current I₂. However, gain trimming circuit 404 can also be configured to directly receive temperature compensated current I₂ to provide a digitally trimmed signal I₃.

In accordance with an exemplary embodiment, output reference V_{OUT} can be buffered by a unity gain buffer A₃ to provide a bandgap reference voltage V_{BG}; however, output reference V_{BG} can also be generated by output reference V_{OUT} without unity gain buffer A₃, or with any other of additional amplifier arrangement.

DAC device 406 can comprise various configurations for facilitating gain trimming of temperature compensated voltage V_{TC2}. For example, DAC device 406 can suitably comprise any conventional current output DAC device configured for receiving a voltage reference, e.g., gate-source voltage V_{GS3}, and for providing a trimmed current I₃. DAC device 406 can also comprise an internal DAC device used for manufacturing trim of a bandgap reference circuit, or a separate DAC device, and can be suitably controlled in various manners. In addition, DAC device 406 can comprise various sizes and resolution, for example an 8-bit DAC device, a 16-bit device, or any other desired configuration. As a result of DAC device 406, fine programming gain steps can be utilized for high precision and accuracy. Thus, for example if an output voltage of 1.250 volts is desired from a bandgap reference circuit, with an accuracy of +/−5 millivolts, and temperature compensated voltage V_{TC} provides only a value of 1.100 volts, an exemplary programmable gain circuit can provide an additional 0.150 volts of gain to obtain the desired level of 1.250 volts.

With additional reference again to FIG. 5, an exemplary gain trim DAC device may also be configured within bandgap reference circuit 506 of microcontroller device 500, and can be suitably controlled by a central processing unit (CPU) 504. For example, in accordance with an exemplary embodiment, an exemplary gain trim DAC device can be suitably programmed through on-chip flash memory 502 configured for storing trim values and loading those values into an exemplary gain trim DAC device, such as during reset and/or power-on phases of the microcontroller circuit, or during any other package level trimming opportunity. Such trim values can be suitably stored at designated addresses within flash memory 502 for suitably retrieval until a desired time for loading is determined. As a result, such trim values can be suitably stored for through data retention techniques for lengthy periods of time.

The present invention has been described above with reference to an exemplary embodiment. However, those skilled in the art will recognize that changes and modifications may be made to the exemplary embodiment without departing from the scope of the present invention. For example, while various exemplary embodiments are configured with CMOS transistors that can provide linear-design architecture and possibly eliminating switch-cap noise within the DAC devices, the various components may be configured with bipolar transistors. These alternatives can be suitably selected depending upon the particular application or in consideration of any number of factors associated with the operation of the system. These and other changes or modifications are intended to be included within the scope of the present invention, as expressed in the following claims.

1. A bandgap reference circuit for providing a high-precision reference voltage, said bandgap reference circuit comprising:
a temperature curvature compensation circuit configured for providing compensation for a temperature coefficient characteristic of said bandgap reference circuit; and
a programmable gain circuit configured for adjusting gain of a temperature compensated output signal of said temperature curvature compensation circuit after packaging of said bandgap reference circuit.

2. The bandgap reference circuit according to claim 1, wherein said temperature curvature compensation circuit and said programmable gain circuit are configured for digital trimming.

3. The bandgap reference circuit according to claim 2, wherein said temperature curvature compensation circuit is digitally trimmed through a first DAC and said programmable gain circuit is digital trimmed through a second DAC.

4. The bandgap reference circuit according to claim 1, wherein said temperature curvature compensation circuit comprises a negative temperature coefficient generating circuit and a positive temperature coefficient generating circuit, said positive temperature coefficient generating circuit being configured for digital trimming to provide said temperature compensated output signal.

5. The bandgap reference circuit according to claim 4, wherein said negative temperature coefficient generating circuit comprises a multiplier circuit configured for multiplying a base-emitter voltage having a negative temperature coefficient.

6. The bandgap reference circuit according to claim 5, wherein said multiplier circuit comprises a servo amplifier circuit and a resistor network configured for multiplying said base-emitter voltage.

7. The bandgap reference circuit according to claim 4, wherein said positive temperature coefficient generating circuit comprises a temperature compensation trim DAC device configured for digitally trimming a positive temperature coefficient of a current reference.

8. The bandgap reference circuit according to claim 7, wherein said DAC device is configured for receiving a proportional-to-absolute-temperature current reference and for providing a trimmed current comprising a binary-weighted representation of said proportional-to-absolute-temperature current reference to generate through a resistor said temperature compensated output signal.

9. The bandgap reference circuit according to claim 1, wherein said programmable gain circuit comprises a gain trim DAC device configured for digitally trimming gain of said temperature compensated output signal.

10. The bandgap reference circuit according to claim 9, wherein said gain trim DAC device is configured for receiving a voltage reference.

11. The bandgap reference circuit according to claim 10, wherein said voltage reference is generated by an additional curvature compensation component.

12. The bandgap reference circuit according to claim 9, wherein said gain trim DAC device is configured for programming through flash memory.

13. An microcontroller configured for providing of a programmable voltage reference, said microcontroller comprising:
a central processing unit;
a flash memory for storage of programming values, said flash memory controlled by said central processing unit; and
a bandgap reference circuit for providing a high-precision reference voltage, said bandgap reference circuit controlled by said central processing unit, said bandgap reference circuit comprising:
a temperature curvature compensation circuit configured for providing a temperature compensated output signal; and
a programmable gain circuit configured for adjusting gain of said temperature compensated output signal after packaging of said microcontroller circuit.

14. The microcontroller according to claim 13, wherein said temperature curvature compensation circuit and said programmable gain circuit are configured for digital trimming.

15. The microcontroller according to claim 14, wherein said temperature curvature compensation circuit is digitally trimmed through a first DAC and said programmable gain circuit is digital trimmed through a second DAC.

16. The microcontroller according to claim 15, wherein at least one of said first DAC and said second DAC are programmed with said programming values of said flash memory.

17. The microcontroller according to claim 16, wherein said flash memory loads said programming values into at least one of said first DAC and said second DAC during a reset of said microcontroller.

18. The microcontroller according to claim 13, wherein said temperature curvature compensation circuit comprises a negative temperature coefficient generating circuit and a positive temperature coefficient generating circuit, said positive temperature coefficient generating circuit comprising a temperature compensation trim DAC device configured for digitally trimming a positive temperature coefficient of a current reference to provide said temperature compensated output signal.

19. The microcontroller according to claim 18, wherein said temperature compensation trim DAC device is configured for receiving a proportional-to-absolute-temperature current reference and for providing a trimmed current comprising a binary-weighted representation of said proportional-to-absolute-temperature current reference to generate through a resistor said temperature compensated output signal.

20. The microcontroller according to claim 13, wherein said programmable gain circuit comprises a gain trim DAC device configured for digitally trimming gain of said temperature compensated output signal.

21. The microcontroller according to claim 20, wherein said gain trim DAC device is configured for receiving a voltage reference generated by an additional curvature compensation component.

22. The microcontroller according to claim 20, wherein said gain trim DAC device is configured for programming through said flash memory.

23. A bandgap reference circuit for providing a high-precision reference voltage, said bandgap reference circuit comprising:
a temperature curvature compensation circuit configured for providing a temperature compensated output signal; and
a programmable gain circuit configured for trimming gain of said temperature compensated output signal after packaging of said bandgap reference circuit; and
wherein each of said temperature curvature compensation circuit and said programmable gain circuit is configured for digital trimming.

24. A method for providing a high-precision reference voltage in a bandgap reference circuit, said method comprising:
digitally trimming a temperature compensated output signal in a temperature curvature compensation circuit; and
digitally trimming gain of said temperature compensated output signal in a programmable gain circuit; and
wherein said temperature curvature compensation circuit and said programmable gain circuit are configured for digital trimming after packaging of said bandgap reference circuit.
